(19) United States
(12) Patent Application Publication
(10) Pub. No.: US 2008/0157910 A1
(43) Pub. Date: Jul. 3, 2008

(54) Amorphous soft magnetic layer for on-die inductively coupled wires

(76) Inventors: Chang-Min Park, Portland, OR (US); Arnel M. Fajardo, Beaverton, OR (US)

Correspondence Address: INTEL/BLAKELY, 1279 OAKMEAD PARKWAY, SUNNYVALE, CA, 94085-4040, US

(21) Appl. No.: 11/647,619

(22) Filed: Dec. 29, 2006

(51) Int. Cl. H01F 27/00; B05D 5/12

(52) U.S. Cl. 336/110; 427/131; 427/132

(57) ABSTRACT

On-die inductively coupled wires and a method of making on-die inductively coupled wires are described. The on-die inductively coupled wires include a first wire to carry a first current, a surface area bounded by a second wire, and, an amorphous soft magnetic layer to couple magnetic flux induced by the first current through the surface area.

### FIELD OF INVENTION

The field of invention relates generally to on-die inductively coupled wires, and, more specifically, to on-die inductively coupled wires having improved electrical power consumption efficiency through reduced eddy currents.

### BACKGROUND

FIG. 1 shows a pair of magnetically coupled or “inductively coupled” wires 130. Inductively coupled wires couple magnetic flux, generated by a time varying signal that flows through a primary wire, through the cross section of a surface area bounded by the winding of a secondary wire. Inductively coupled wires may be used to form various electrical components such as an inductor or a transformer.

Referring to FIG. 1, wire 109 corresponds to the primary wire and wire 110 corresponds to the secondary wire 110. A time varying signal Ip flows through the primary wire and generates a circular magnetic field H according to Ampere's law (Δ×H=Jp where Jp is the current density of the primary signal Ip). A magnetic core 104 that surrounds both the primary and secondary wires 109, 110 essentially converts the magnetic field H generated by the time-varying primary signal Ip into a strong magnetic flux density β that circulates around the magnetic core 104 and flows through the cross section of a surface area A bounded by the secondary wire 110. A secondary time-varying signal Is is generated in the secondary wire 110 owing to Faraday's law (Δ×E=−∂Φ/∂t where ∂Φ/∂t is the time rate of change of the magnetic flux that flows through cross section A and E is the electric field induced in the secondary wire 110 that causes the secondary signal Is to flow).

In order to create a strong “coupling” between the induced signal Is and the primary signal Ip, the magnetic properties of the magnetic core 104 should be sufficiently “soft”. Referring to the hysteresis loop 140 of FIG. 1, soft magnetic materials are understood to exhibit high saturation magnetic flux density B_{SAT} and low coercivity Hc. As the magnetic field H generated by the primary signal Ip extends beyond the coercivity of the magnetic core (which may occur even at weak primary signal Ip strengths owing to the low coercivity Hc of the magnetic core) the magnetic flux density B that circulates around the magnetic core rapidly increases in response (owing to the high B_{SAT} of the magnetic core). As a consequence a significant amount of magnetic flux flows through cross section A.

The strength of the magnetic field strength H may be made to increase for a given primary signal by looping the primary wire around the magnetic core a number of times. Similarly, the magnitude of the response signal Is may be made to increase by looping the secondary wire a number of times around the magnetic core 104. The magnetic properties of the core 104 and the number of windings associated with the primary and/or secondary signals may be specially designed so that the inductively coupled wires can be used as a transformer where the amplitudes of the primary and secondary signals have a specific designed for ratio. In the case of a 1:1 primary: secondary winding ratio (i.e., each wire runs once through the core) the inductively coupled wires effectively form an inductor in which a voltage V appears across the secondary wire as a function of K(∂Ip/∂t).

A problem with inductively coupled wires is the generation of eddy currents within the magnetic core. Here, the phenomena described by Faraday's law induces electrical currents to flow within the magnetic core 104. These currents cause the magnetic core to consume electrical power owing to the electrical power consumption relationship P=I²R where P is the electrical power consumed by the magnetic core, I is the magnitude of an eddy current that flows through the magnetic core and R is the electrical resistance of the magnetic core through which the eddy current flows. The power consumption of the magnetic core can be reduced by increasing the inherent resistivity of the magnetic core 104. Here, a higher resistivity will result in less eddy current in the magnetic core. This, in turn, drops the overall power consumption of the core because power consumption is a function of the square of the eddy current flow.

### BRIEF DESCRIPTIONS OF THE DRAWINGS

FIG. 1 shows inductively coupled wires;

FIG. 2 shows on-die inductively coupled wires;

FIGS. 3A through 3H together show a manufacturing process for constructing conductively coupled wires;

FIG. 4 shows a computing system.

### DETAILED DESCRIPTION

In the manufacture of electronic systems, there exists economic efficiency in integrating as many electronically interconnected components as possible with a single manufacturing process. This often results in a motivation to combine as many electronic components as possible onto a single “die” of processed semiconductor material. Moreover, it is not uncommon for a packaged semiconductor chip to be designed to use a voltage regulator that that is located external to the semiconductor chip package on the same “planar” or “PC board” that the semiconductor chip package is mounted to. The voltage regulator essentially suppresses variations in a power supply voltage that is ideally a constant, DC voltage. As is well known in the art, voltage regulators may be built with an “LC” filter where L corresponds to an inductor that physically resides external to the semiconductor chip package.

With the need for a voltage regulator and the need to integrate as many electronic components onto a semiconductor die as is possible, a motivation exists to build “on-die” voltage regulators. That is, a motivation exists to construct a voltage regulator into the various layering of conductive and dielectric materials that are processed onto a semiconductor wafer, which is subsequently cut into a “die and packaged.

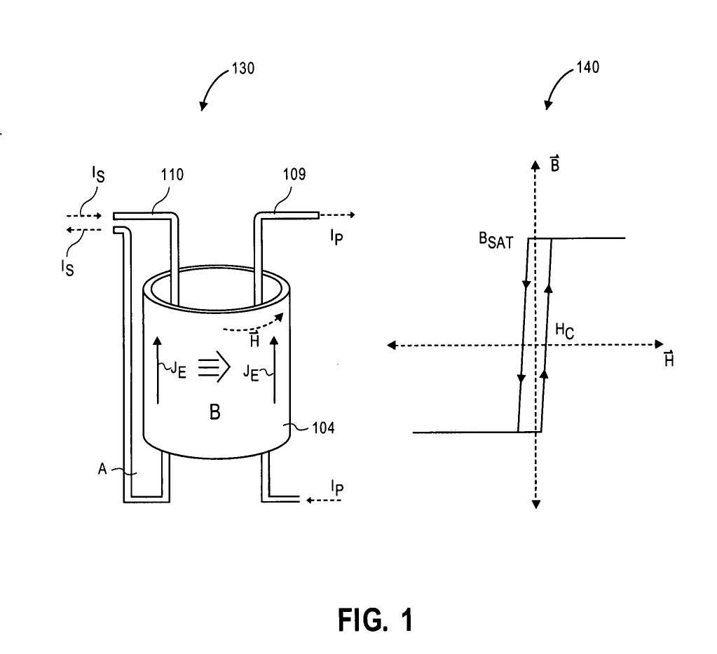

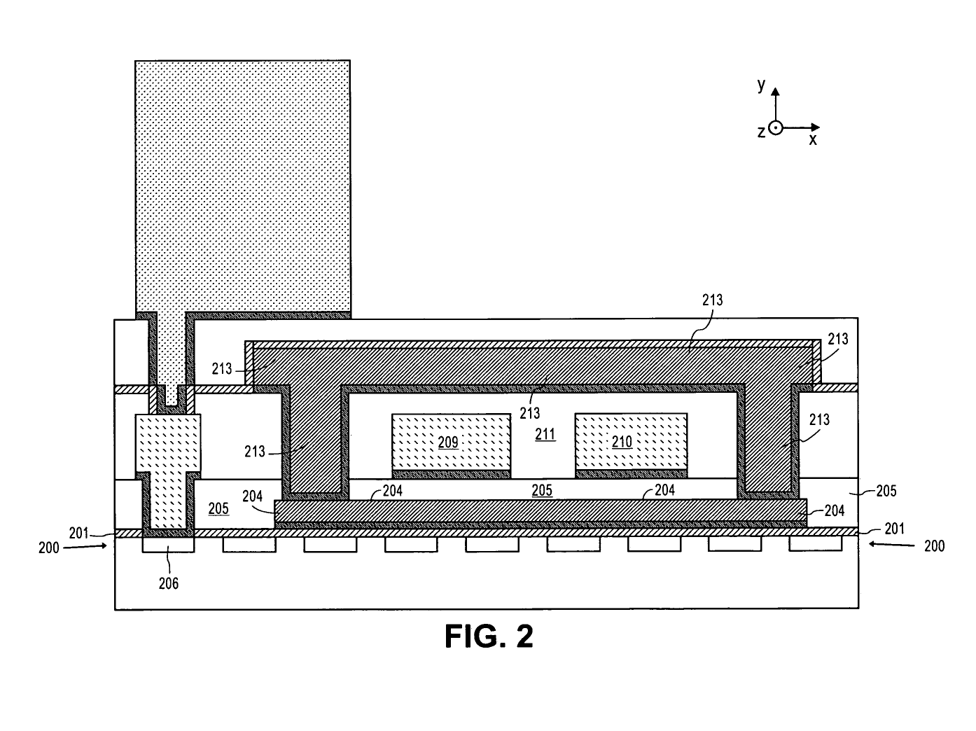

By eliminating the need for an external voltage regulator printed circuit board space is conserved which should lower the manufacturing costs of the printed circuit board end-product. FIG. 2 shows “on-die” inductively coupled wires whose design is similar to the inductively coupled wires depicted in FIG. 1. In an implementation, the inductively coupled wires are used as an inductor within an LC circuit that is used by a voltage regulator circuit that is also manufactured “on-die”.

According to the on die inductively coupled wiring design of FIG. 2, the highest layer of transistor-to-transistor interconnect wiring in represented as layer 200. Here, feature 206 corresponds to the cross-section of one “highest level transistor interconnect” wire. The inductively coupled wires are constructed over the highest layer interconnect wire 200. A dielectric nitride layer 201 insulates the highest level interconnect wiring 200 from the inductively coupled wiring structure. The inductively coupled wiring structure is essentially constructed from a lower magnetic layer 204 and a higher magnetic layer 213 that are connected so as to surround primary wiring 209 and secondary wiring 210 with magnetic material similar to the manner in which the primary and secondary wires 109, 110 of FIG. 1 are surrounded by soft magnetic material 104. The primary and secondary wires 209, 210 are electrically isolated from the surrounding magnetic material 204, 213 by the presence of a lower dielectric layer 205 and a higher dielectric layer 211.

In order to reduce the detrimental effects of eddy currents, the magnetic core material constructed from magnetic layers 204, 213 should exhibit sufficiently high electrical resistance while maintaining sufficiently “soft” magnetic properties. As described in the background, high electrical resistance suppresses the flow of any induced eddy currents. That is, the overall magnitude of induced electrical current flow from eddy currents will be lower in a magnetic core material having higher electrical resistance than an otherwise identical magnetic core material having lower electrical resistance. Because the magnitude of the induced eddy currents is lower, the energy loss (or power consumption) of the inductively coupled wires will be reduced resulting in a more electrically efficient device. Also, for the reasons discussed above in the background with respect to the hysteresis loop of FIG. 1, the magnetic core material should still be sufficiently soft. That is, provide a sufficiently high magnetic flux density while exhibiting a sufficiently low coercivity. In so doing, the inductively coupled wires will exhibit efficient magnetic flux linkage between the primary wiring and the secondary wiring.

The following dimensions as depicted in FIG. 2 may apply (all ranges being inclusive): 1) primary wire 209 length=500-1000 μm; 2) primary wire 209 width=10-50 μm; 3) secondary wire 210 width=10-50 μm; 4) secondary wire 210 length=500-1000 μm; 5) lower dielectric layer 205 thickness=1-20 μm; 6) higher dielectric layer 211 thickness 220=5-20 μm; 7) lower magnetic layer 204 thickness=0.1-5 μm; 8) lower magnetic layer 204 width=100-200 μm; 9) lower magnetic layer 204 length=500-1000 μm; 10) higher magnetic layer 213 thickness=5-30 μm; 11) higher magnetic layer 213 width=0.1-5 μm; and, 12) higher magnetic layer 213 length=100-200 μm. Here, width is measured horizontally along the x axis of FIG. 2, thickness is measured vertically along the y axis FIG. 2 and length is measured “in-and-out” along the z axis FIG. 2.

According to this design, sufficiently soft magnetic properties for both the lower and higher magnetic layers 204, 213 corresponds to a saturation magnetic flux density (β_{SAT}) of greater than 1.0 Tesla (T) and a magnetic coercivity (Hc) of less than 10.0 Oersteds (Oe)). Moreover, in order to sufficiently suppress the magnitude of induced eddy currents, both the lower and higher magnetic layers 204, 213 are also designed to have resistivities higher than 140 μΩ·cm and preferably at least as high as 400 μΩ·cm. Here, note that the magnetic flux density and the coercivity are each measured along the x axis while the resistivity is measured along the z axis of FIG. 2.

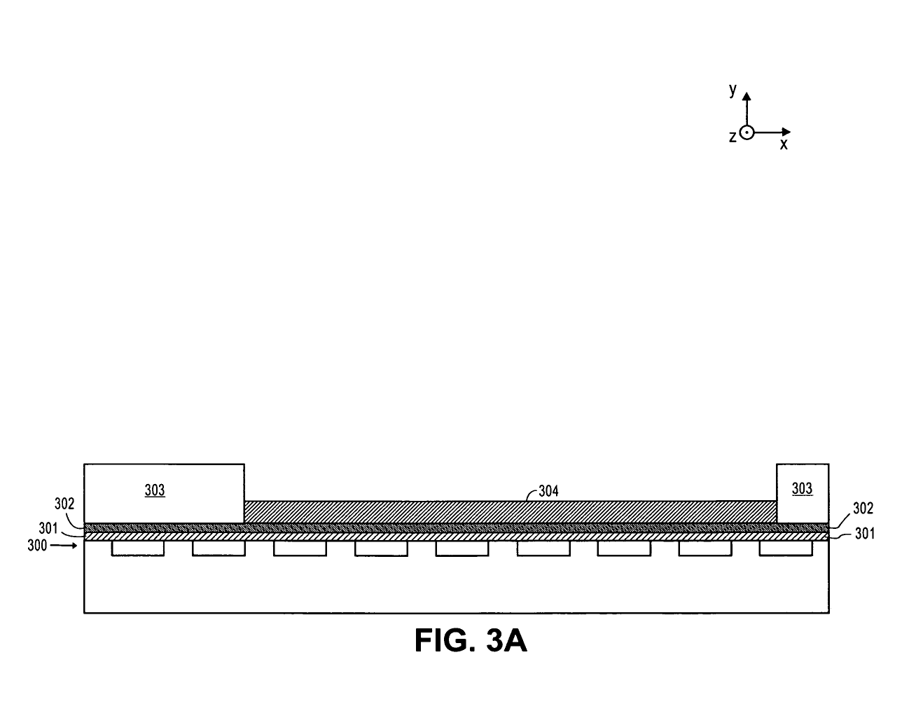

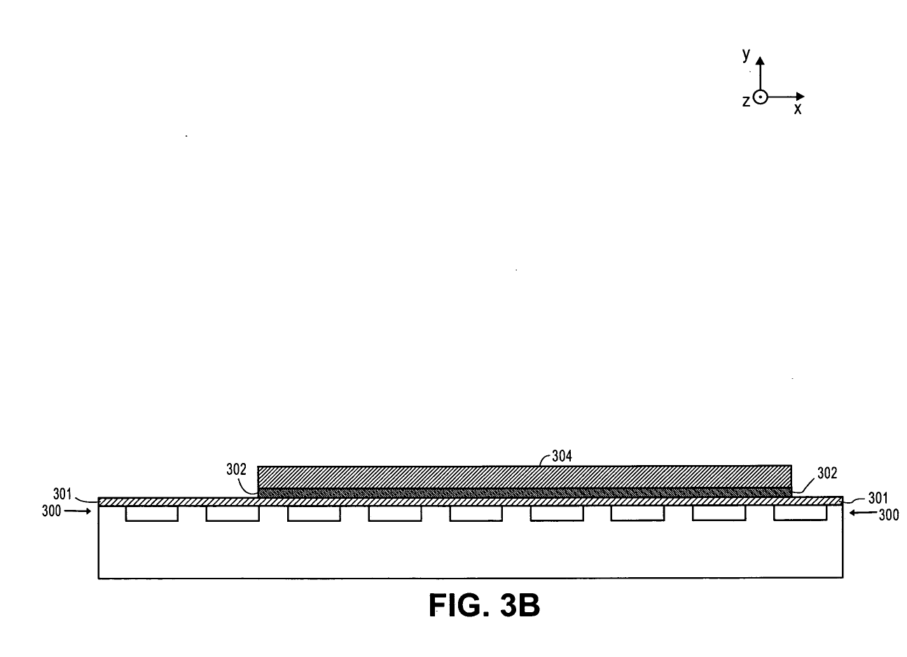

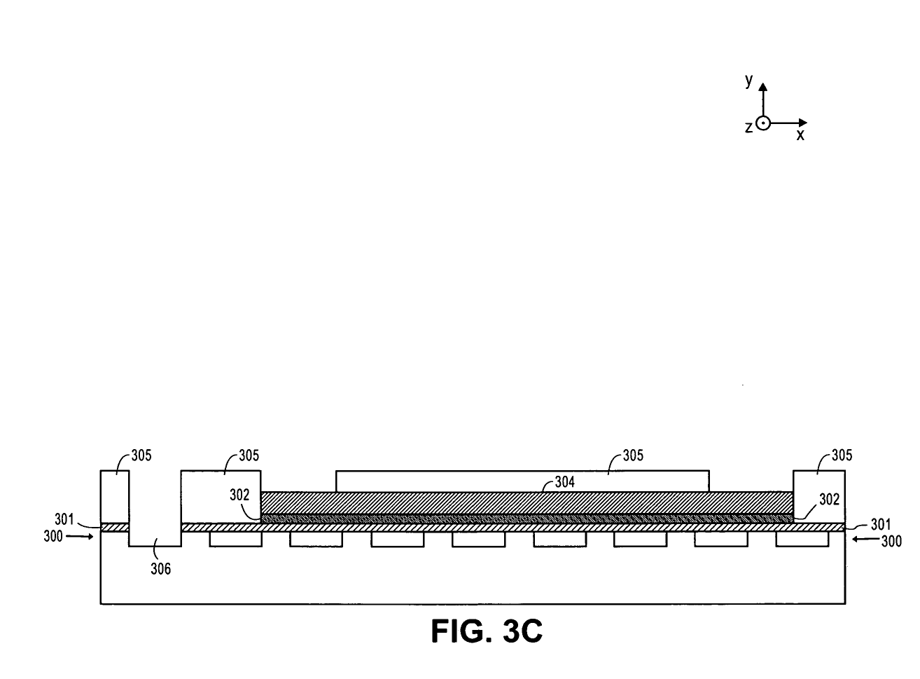

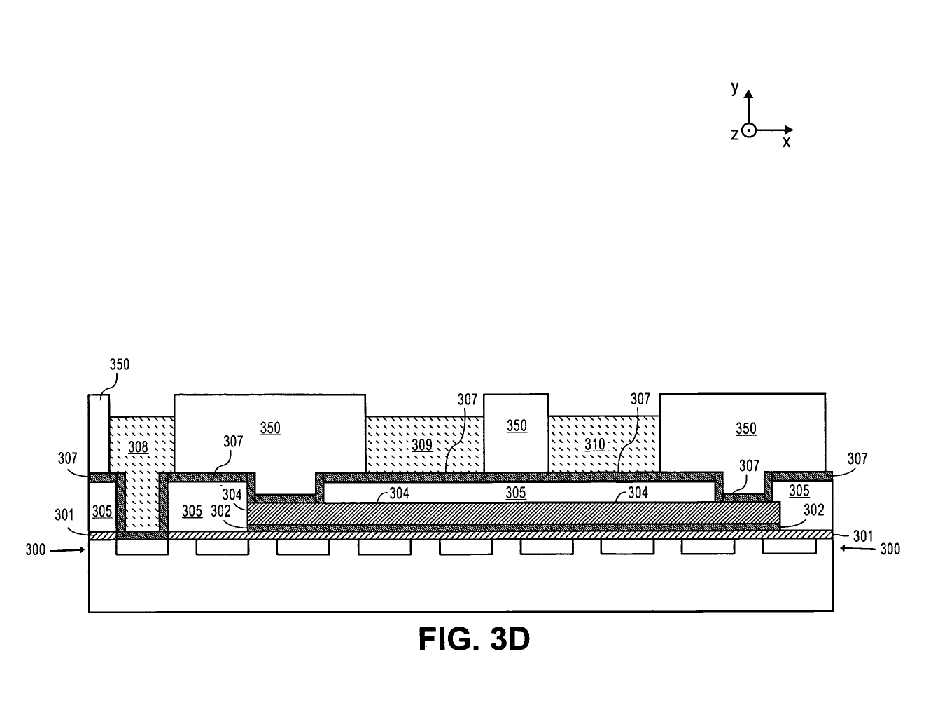

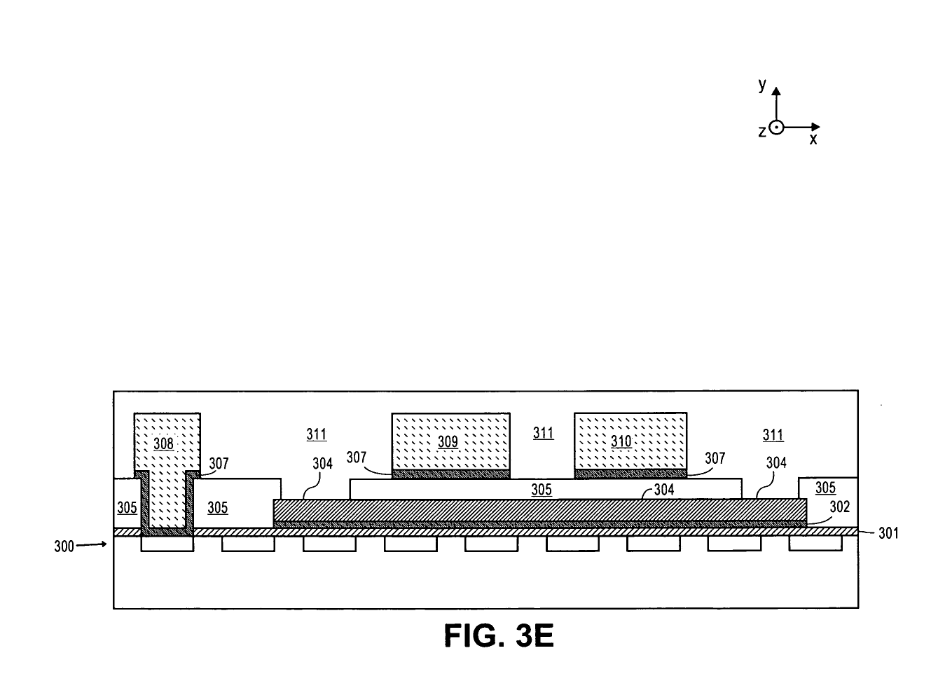

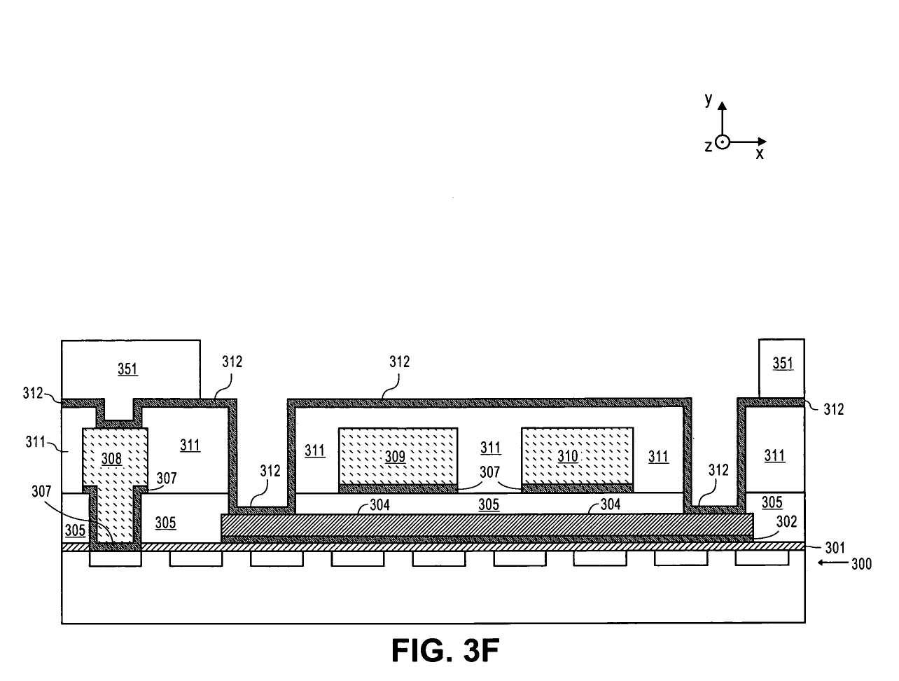

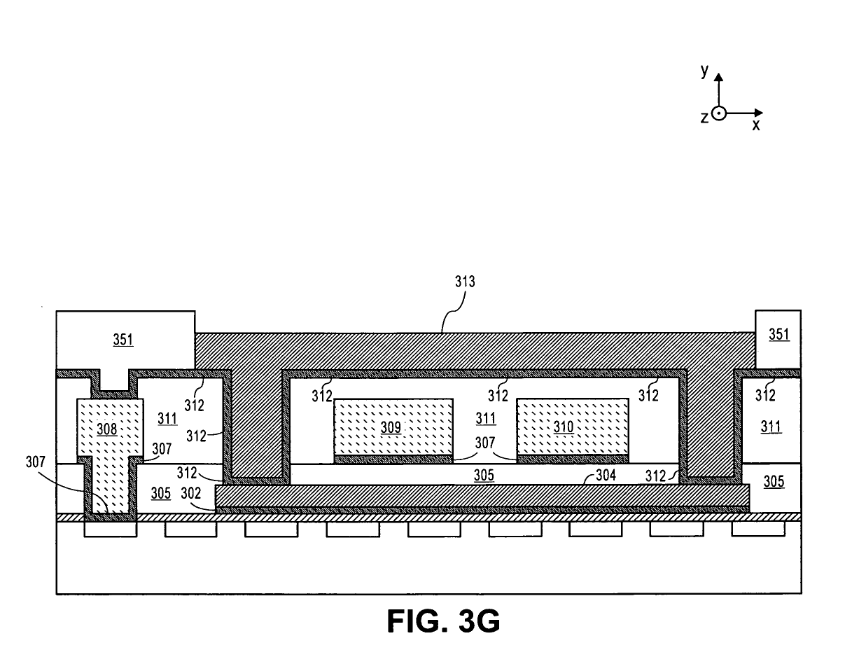

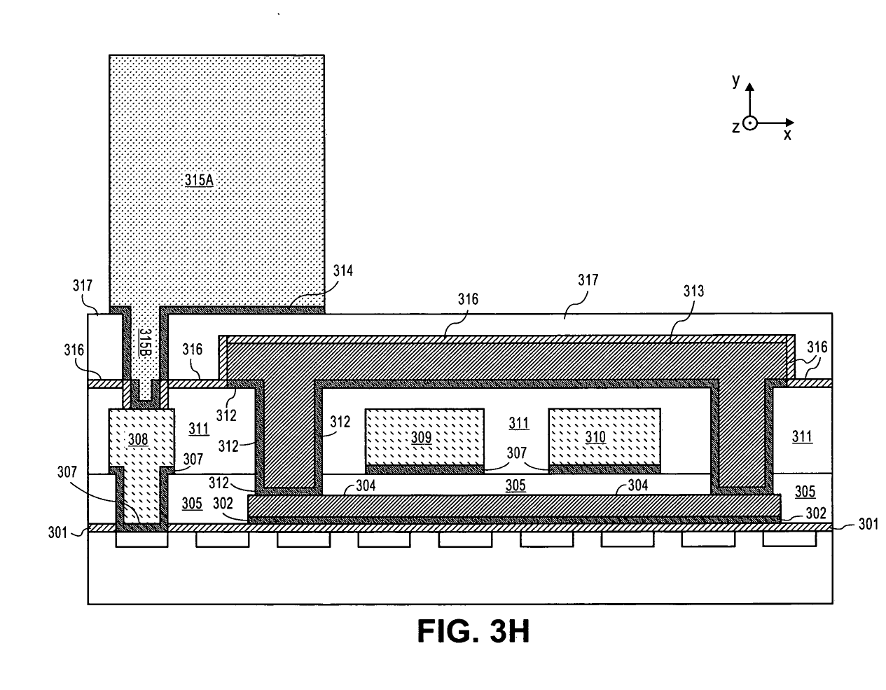

FIGS. 3_A through 3_G show a process flow for forming on die inductively coupled wires as described above including magnetic layering having both sufficiently soft magnetic properties to maintain magnetic coupling efficiency and sufficiently high resistivity to improve power dissipation efficiency. According to FIG. 3_A, a nitride passivation layer 301 (e.g., Si₃N₄) is coated over the highest interconnect metal wiring level 300 that has been formed over the semiconductor die. Then, a seed layer 302 for promoting the deposition of the lower magnetic layer, discussed in more detail below, is deposited by plasma vapor deposition (PVD) over the nitride layer 301. According to one possible approach, the seed layer 302 may be any of Copper (Cu), Cobalt (Co), Platinum (Pt), Palladium (Pd), an alloy of Aluminum (Al) or an alloy of AlₓCu₁₋ₓ or NiₓFe₁₋ₓ (where x is within a range of 0-1). Ranges of process parameters suitable for depositing the seed layer by PVD include: 1) wafer pressure=3000-6000 mtorr; 2) DC power=4000-40000 Watts; 3) Ar gas flow=2-20 sccm; 4) temperature set point=20-35° C.

After the seed layer 302 is deposited, a layer of photoresist 303 is coated over the wafer (e.g., by being spun on) and is patterned with photolithography techniques to form an opening where the lower magnetic layer is to be formed. The lower magnetic layer 304 is then formed by electroless-plating or electroplating an Cobalt(Co)-Tungsten(W)-Boron(B) film over the seed layer 302 in the presence of an applied magnetic field along the x axis. As discussed more thoroughly below, the lower magnetic layer 304 is formed with a sufficient amount of Co to keep the film “soft” in magnetic terms and with a sufficient amount of W and B to keep the film amorphous so that the electrical resistivity of the film is high. Workable respected percentage ranges of W and B are believed to be approximately 10-40% for W and 1-10% for B.

A pertinent aspect associated with a magnetic film 304 made of Co, W and B is that the film 304 is amorphous rather than single crystalline because of the introduction of W and B. Here, because of the non-uniformity in the arrangement of the atoms within an amorphous layer, a higher resistivity results as compared to a single crystalline film (which would have a continuous and regular arrangement of atoms) or a poly-crystalline film (which would have sizeable grains of crystalline material). Thus, in a more general sense, the higher resistance stems from the purposeful deposition of an amorphous magnetic layer 304.

Moreover, the lower magnetic layer 304 is kept sufficiently soft (magnetically speaking) due to its amorphous nature and the application of the applied magnetic field during the layer's deposition. The application of the magnetic field during the deposition of the lower magnetic layer 304 causes the film to exhibit uniaxial anisotropy such that the magnetic moment of the film “prefers” to point substantially in either direction along the x axis. The uniaxial anisotropy, the high B_{SAT} and the low coercvity all stem from the sufficiently high percentage of Co in the lower magnetic layer.

As mentioned above, the lower magnetic layer may be formed with either electroless-plating or electroplating. According to one embodiment, the plating bath for the deposition of the lower magnetic layer 304 includes: 1) 0.01 to 0.05 Moles/Liter (M) of Co²⁺; 2) 0.1-0.5 M of a complexing agent to prevent the precipitation of Co hydroxide from the solution at high pH levels (a possible complexing agent includes citrate); 3) 0.001-0.05 M of a sulfate or chloride electrolyte that includes WO₄²⁻ (here, the sulfate or chloride acts as counter ion for charge neutrality to counter-balance the presence of Co²⁺ ions, and, the WO₄²⁻ acts as a source of W for deposition); 4) a pH buffer such as BO₃³⁻ to help maintain a constant pH level of the solution; and, 5) 0.02-0.2 M of dimethylamineborane ((CH₃)₂NH:BH₃) which acts as a source of boron as well as a reducing agent (i.e., a source of electrons to convert the Co²⁺ ions into Co atoms for deposition). According to one embodiment, the pH level is kept within a range of 8.3-9.7, the temperature is kept within a range of 50° C. to 80° C. and the applied electric field is within a range of 100 Oe-1000 Oe.

The applicable chemical reactions are as follows.

For the deposition of Co:

(CH₃)₂NH:BH₃+3H₂O+OH⁻+3Co²⁺(CH₃)₂NH₂⁺+B(OH)₄⁻+5H⁺+3Co Eqn. 1.

For the deposition of W:

WO₂²⁺+(CH₃)₂NH:BH₃+4H₂O→W+(CH₃)₂NH₂⁺+B(OH)₄⁻+3H Eqn. 2.

For the deposition of B:

(CH₃)₂NH:BH₃+H+⁺→BH₃+(CH₃)₂NH₂⁺+B+1.5H₂+(CH₃)₂NH⁺ Eqn. 3

Magnetically soft amorphous layers having resistivities as high as 700 μΩ·cm have been achieved with the above described process.

As mentioned above the seed layer 302 is used to initiate these chemical reactions. According to one approach, the minimum thickness of the seed layer 302 is bounded so that the magnetic layer does not oxidize during the highest temperatures that will be applied to the wafer during subsequent processing. As the particular inductively coupled wires depicted in FIGS. 3hd —A through 3_G is constructed above the highest layer of metal interconnect 300, the highest temperatures are expected to be no higher than 200° C. to 300° C. for current processes. The maximum thickness of the seed layer is bounded so that the magnetic properties of the magnetic layer are not diluted. It is believed that a seed layer thickness range of 200 to 800 Å should be sufficient for current processes.

Referring to FIG. 3_B, after the lower magnetic layer 304 is formed, the photoresist layer 303 (see FIG. 3A) and the portion of the seed layer 302 directly beneath the photoresist layer 303 are removed. The photoresist layer 303 may be removed by a wet etch and the seed layer 302 may be removed by a wet etch. Then, as depicted in FIG. 3_C, the lower layer dielectric 305 (e.g., as composed of a nitride such as Si₃N₄) is deposited or spun over the surface of the wafer (e.g., by physical or chemical deposition), photoresist is applied, patterned and etched (not shown) leaving open vias above the lower magnetic layer 304 and any I/O wire (such as I/O wire 306) requiring electrical contact to an I/O (such as a solder ball, C4 joint, etc.).

After etching any nitride layer 301 that resides over an I/O wire 306 to expose the I/O wire 306 (noting that the portions of the nitride layer 301 beneath magnetic layer 304 and lower dielectric layer 305 are not removed by the etch because they are protected by respective layers 304, 305), referring now to FIG. 3D, barrier/seed layer 307 is deposited over the lower dielectric 305 and the exposed areas of the lower magnetic layer 304 and I/O wire 306. According to one implementation, the barrier/seed layer 307 is composed of Cu and Titanium (Ti) and is deposited by physical vapor deposition such as evaporation or sputtering.

Another layer of photoresist 350 is deposited, patterned and etched to create regions where electrically conductive wiring such as contact via 308 and primary and secondary wires 309 and 310, respectively are later deposited. In one embodiment the electrically conductive wiring is composed of Cu. In this case, the barrier/seed layer 307 acts as a barrier layer for the Cu contact via 308 and primary, secondary wiring metal 309, 310. After removing the photoresist 350, the higher layer dielectric 311 is then deposited or spun on over the wafer as depicted in FIG. 3_E.

Another layer of photoresist (not shown) is subsequently applied, patterned and etched to expose openings over any contact vias (such as contact via 308) and over the lower magnetic layer 304 where the interlayer lower and higher magnetic layers are to be connected. As depicted in FIG. 3_F, after removing the photoresist, another seed layer 312 similar to seed layer 302 is then deposited over the wafer. According to one embodiment, seed layer 312 (like seed layer 302) is formed by depositing Cu, Co, Pt, Pd, an Al alloy or an AlₓCu₁₋ₓ alloy. Another layer of photoresist 351 is then applied, patterned and etched to form an opening where the higher magnetic layer 313 is to be deposited.

As depicted in FIG. 3_G, the higher magnetic layer 313 is deposited. Like lower magnetic layer 304, higher magnetic layer 313 may be a material that includes Co, W and B having enough Co to exhibit soft magnetic properties yet having enough W and B to be amorphous so as to exhibit high resistivity. Also, plating solutions like those described above used to deposit lower magnetic layer 304 may also be used to deposit higher magnetic layer 313. After removing the resist, seed layer 312 is removed everywhere except beneath the higher magnetic layer 313.

Referring to FIG. 3H, passivation 316 and polymer 317 layers are then successively formed over the wafer. Photoresist is applied, patterned and etched to form openings over the passivation and polymer residing over any contact vias such as contact via 308. The passivation and polymer layers residing over a contact via 308 are then removed and another seed layer 314 (e.g., an alloy of Ti and Cu) is formed over the wafer so as to at least cover the exposed contact via 308. Contacts (e.g., solder bumps, C4 balls, etc.) are then formed over the contact via 308 including a second, stacked via 315b between the actual contact 315a and via 308. The portions of the seed layer 314 that are not protected by contact 316 are then etched away.

It will be evident to one of ordinary skill that the secondary wire 210, 310 of FIGS. 2 and 3H may be routed back around an end of the magnetic core to form a cross section of surface area bounded by the secondary wire that magnetic flux within the magnetic core will flow through. Conceivably, in order to form a transformer, either or both the primary and secondary wires may be looped around the magnetic core as well. In this case, a cross section of the inductively coupled wires might reveal any such looped wire to be stacked within the dielectric that is surrounded by the magnetic core. For instance, if the secondary wire were looped three times around the magnetic wire, three separate secondary wire cross sections might be observed stacked upon each other within dielectric region 305, 311. In this case, the separation of the higher and lower magnetic layers may be increased to account for the stacked wiring within the region bounded by the magnetic core.

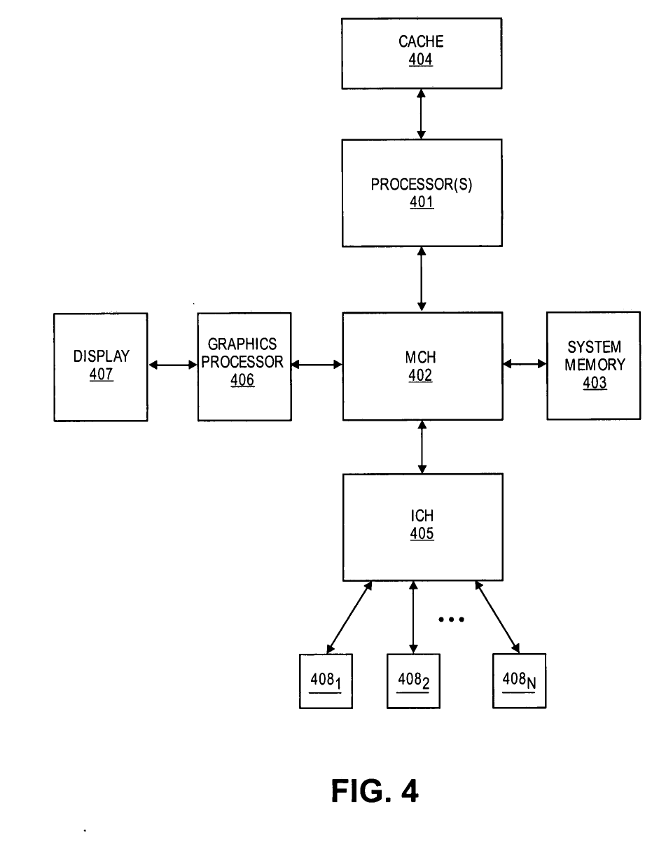

The semiconductor die on which the inductively coupled wires are integrated may be a semiconductor die used to implement a component within a computing system. FIG. 4 shows an embodiment of a computing system (e.g., “a computer”) and some of its various components. The exemplary computing system of FIG. 4 includes: 1) one or more processors 401; 2) a memory control hub (MCH) 402; 3) a system memory 403 (of which different types exist such as DDR RAM, EDO RAM, etc,); 4) a cache 404; 5) an I/O control hub (ICH) 405; 4) a graphics processor 406; 4) a display/screen 407 (of which different types exist such as Cathode Ray Tube (CRT), Thin Film Transistor (TFT), Liquid Crystal Display (LCD), DPL, etc.; 8) one or more I/O devices 408.

The one or more processors 401 execute instructions in order to perform whatever software routines the computing system implements. The instructions frequently involve some sort of operation performed upon data. Both data and instructions are stored in system memory 403 and cache 404. Cache 404 is typically designed to have shorter latency times than system memory 403. For example, cache 404 might be integrated onto the same silicon chip(s) as the processor(s) and/or constructed with faster SRAM cells whilst system memory 403 might be constructed with slower DRAM cells. By tending to store more frequently used instructions and data in the cache 404 as opposed to the system memory 403, the overall performance efficiency of the computing system improves

System memory 403 is deliberately made available to other components within the computing system. For example, the data received from various interfaces to the computing system (e.g., keyboard and mouse, printer port, LAN port, modem port, etc.) or retrieved from an internal storage element of the computing system (e.g., hard disk drive) are often temporarily queued into system memory 403 prior to their being operated upon by the one or more processor(s) 401 in the implementation of a software program.

Similarly, data that a software program determines should be sent from the computing system to an outside entity through one of the computing system interfaces, or stored into an internal storage element, is often temporarily queued in system memory 403 prior to its being transmitted or stored. The ICH 405 is responsible for ensuring that such data is properly passed between the system memory 403 and its appropriate corresponding computing system interface (and internal storage device if the computing system is so designed).

The MCH 402 is responsible for managing the various contending requests for system memory 403 access amongst the processor(s) 401, interfaces and internal storage elements that may proximately arise in time with respect to one another. One or more I/O devices 408 are also implemented in a typical computing system. I/O devices generally are responsible for transferring data to and/or from the computing system (e.g., a networking adapter); or, for large scale non-volatile storage within the computing system (e.g., hard disk drive). ICH 405 has bi-directional point-to-point links between itself and the observed I/O devices 408.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

We claim:

1. On-die inductively coupled wires, comprising:
a) a first wire to carry a first current;
b) a surface area substantially bounded by a second wire; and,
c) an amorphous soft magnetic layer to couple magnetic flux induced by said first current through said surface area.

2. The on-die inductively coupled wires of claim 1 wherein said magnetic layer comprises Cobalt (Co), Tungsten (W) and Boron (B).

3. The on-die inductively coupled wires of claim 2 wherein said magnetic layer's percentage of W is within a range of 10-40% inclusive.

4. The on-die inductively coupled wires of claim 3 wherein said magnetic layer's percentage of B is within a range of 1-10% inclusive.

5. The on-die inductively coupled wires of claim 2 wherein said amorphous soft magnetic layer has a saturation magnetic flux density greater than 1 Tesla, a coercivity less than 10 Oersteds and an electrical resistivity greater than 140 μΩ·m.

6. The on-die inductively coupled wires of claim 5 wherein said amorphous soft magnetic layer has an electrical resistivity greater than 400 μΩ·cm.

7. The on-die inductively coupled wires of claim 6 wherein said electrical resistivity is approximately 700 μΩ·cm.

8. The on-die inductively coupled wires of claim 1 wherein said amorphous soft magnetic layer has a saturation magnetic flux density greater than 1 Tesla, a coercivity less than 10 Oersteds and an electrical resistivity greater than 140 μΩ·cm.

9. The on-die inductively coupled wires of claim 8 wherein said amorphous soft magnetic layer has an electrical resistivity greater than 400 μΩ·cm.

10. The on-die inductively coupled wires of claim 9 wherein said electrical resistivity is approximately 700 μΩ·cm.

11. The on-die inductively coupled wires of claim 1 wherein said amorphous soft magnetic layer has a uniaxial anisotropy.

12. A method, comprising:
a) preparing a solution comprising:
i) Cobalt ions;
ii) a complexing agent to prevent the precipitation of Co hydroxide from said solution;
iii) WO₄²;
iv) a pH buffer;
v) dimethylamineborane;
b) with said solution, plating an amorphous layer of soft magnetic material comprising Co, W and B and having an electrical resistivity greater than 140 μΩ·cm.

13. The method of claim 12 further comprising maintaining said solution's pH level approximately within a range of 8.3 to 9.7.

14. The method of claim 12 wherein said solution's temperature is kept approximately within a range of 50° C. to 80° C.

15. The method of claim 12 further comprising applying a magnetic field during said plating.

16. The method of claim 12 wherein said pH buffer includes BO₃³⁻.

17. A method, comprising:
a) depositing over a seed layer a first amorphous layer of soft magnetic material comprising Co, W and B and having an electrical resistivity greater than 140 μΩ·cm by:
preparing a solution comprising:
i) Cobalt ions;
ii) a complexing agent to prevent the precipitation of Co hydroxide from said solution;
iii) WO₄²;
iv) a pH buffer;
v) dimethylamineborane;
and with said solution, plating said amorphous layer of soft magnetic material to said seed layer.
b) depositing a dielectric layer;
c) depositing first and second wires within said dielectric layer;
d) depositing a second seed layer above said first and second wires;
e) depositing over said second seed layer a second amorphous layer of soft magnetic material comprising Co, W and B and having an electrical resistivity greater than 140 μΩ·cm by:
preparing a second solution comprising:
i) Cobalt ions;
ii) a complexing agent to prevent the precipitation of Co hydroxide from said solution;
iii) WO₄²;
iv) a pH buffer;
v) dimethylamineborane;
and with said second solution, plating said second amorphous layer of soft magnetic material to said second seed layer.

18. The method of claim 17 wherein said seed layer's material is selected from the group consisting of:
Copper (Cu);
Cobalt (Co);
Platinum (Pt);
Palladium (Pd);
an alloy of Aluminum (Al);
an alloy of AlₓCu₁₋ₓ where x is within a range of 0-1 inclusive;
an alloy of NiₓFe₁₋ₓ where x is within a range of 0-1 inclusive

19. The method of claim 17 further comprising maintaining said solution's pH level approximately within a range of 8.3 to 9.7.

20. The method of claim 17 wherein said solution's temperature is kept approximately within a range of 50° C. to 80° C.

21. The method of claim 17 further comprising applying a magnetic field during both of said platings.

22. The method of claim 17 wherein said pH buffer includes BO₃³⁻.
